(19) United States
(12) Patent Application Publication
(10) Pub. No.: US 2026/0338149 A1
(43) Pub. Date: Oct. 29, 2026

(54) FUEL INJECTOR CAP FOR ENHANCED GASEOUS FUEL MIXING

(71) Applicant: Caterpillar Inc., Peoria, IL (US)

(72) Inventors: Diego Bernardi Bestel, Peoria, IL (US); Bobby John, Peoria, IL (US); Benjamin A. Cantrell, Chillicothe, IL (US); Dean C. Diers, Rapid City, SD (US)

(73) Assignee: Caterpillar Inc., Peoria, IL (US)

(21) Appl. No.: 19/191,919

(22) Filed: Apr. 28, 2025

(51) Int. Cl. F02M 61/18

(52) U.S. Cl. CPC F02M 61/18

(57) ABSTRACT

An injector cap for controlling introduction of gaseous fuel into a combustion chamber of an engine cylinder may include a cap head configured for arrangement at a fuel ejecting tip of a fuel injector with an axial axis along which the fuel injector ejects the gaseous fuel. The cap head may include a slot extending radially into the cap head and defining a fuel dispersion surface arranged generally orthogonal to the axial axis and configured to disperse the gaseous fuel ejected from the fuel injector through the slot.

### GOVERNMENT CONTRACT

This invention was made with government support under the Transient-capable Hydrogen-hybrid for Off-Road (THOR) project award number DE-EE0010606 awarded by the US Department of Energy. The government has certain rights in the invention.

### TECHNICAL FIELD

The present disclosure relates to internal combustion engine technologies. More particularly, the application pertains to fuel injection systems, specifically direct fuel injection. Still more particularly, it involves the design of injector caps for the introduction of gaseous fuels to enhance fuel-air mixing efficiency.

### BACKGROUND

Internal combustion engines, particularly those utilizing direct injection of gaseous fuels, can suffer from poor fuel mixing. For example, for engines using gaseous fuels such as hydrogen, achieving efficient fuel-air mixing can be difficult. Current systems often struggle with low flow rates, especially in engines with larger displacements, which can lead to suboptimal mixing. This inefficiency in mixing can result in increased abnormal combustion events and elevated emissions of nitrogen oxides, which are detrimental to both engine performance and environmental standards.

### SUMMARY

In one or more examples, an injector cap for controlling introduction of gaseous fuel into a combustion chamber of an engine cylinder may include a cap head configured for arrangement at a fuel ejecting tip of a fuel injector with an axial axis along which the fuel injector ejects the gaseous fuel. The cap head may include a slot extending radially into the cap head and defining a fuel dispersion surface arranged generally orthogonal to the axial axis and configured to disperse the gaseous fuel ejected from the fuel injector through the slot.

In one or more examples, an injector cap for controlling introduction of gaseous fuel into a combustion chamber of an engine cylinder may include a cap body for arrangement on the fuel ejecting tip of a fuel injector. The injector may also include a cap head coupled to the cap body and comprising a deflector. The cap head may be configured to receive a flow of gaseous fuel from the fuel injector in an axial direction and, using the deflector, generate a radially propagating and simultaneously expanding flow forming a fan-shaped wave of fuel extending across a top portion of the combustion chamber and generally orthogonal to the axial direction.

### DESCRIPTION OF THE DRAWINGS

FIG. 1 is a schematic diagram illustrating the internal components of an engine cylinder, according to one or more examples.

FIG. 2 is a transparent view of a cylinder head and showing an arrangement of an inlet valve, an exhaust valve, and a fuel injector, according to one or more examples.

FIG. 3 is a side view of a fuel injector with an injector cap, according to one or more examples.

FIG. 4 is a perspective view of the injector cap of the fuel injector of FIG. 3, according to one or more examples.

FIG. 5 is a cross-sectional view of the injector cap of FIG. 4, according to one or more examples.

FIG. 6 is another cross-sectional view of the injector cap of FIG. 4, according to one or more examples.

FIG. 7A is a cross-section view of an injector cap for purposes of comparison to the injector cap of the present application.

FIGS. 7B-7H are progressive depictions of fuel mixing through several stages of an intake stroke based on the injector cap design of FIG. 7A.

FIG. 8A is a cross-section view of an injector cap according to the present disclosure and for purposes of comparison to the injector cap of FIG. 7A.

FIGS. 8B-8H are progressive depictions of fuel mixing through several stages of an intake stroke based on the injector cap design of FIG. 8A.

### DETAILED DESCRIPTION

The application, in one or more examples, pertains to an innovative injector cap designed for use in internal combustion engines. The cap is particularly useful for the direct injection of fuels in gaseous form, such as hydrogen. The injector cap may be configured to enhance fuel-air mixing efficiency by redirecting the gaseous fuel orthogonally using a deflector and allowing it to exit through a slot as a radially travelling fanned out wave. This design addresses the challenges of poor mixing and uneven fuel distribution, which are common in traditional fuel injection systems. By improving the mixing quality, the injector cap may be effective to reduce the occurrence of abnormal combustion events and lower emissions of nitrogen oxides, thereby enhancing engine performance and improving the engine's ability to meet environmental standards. Thus, the injector cap may be effective at improving the combustion process, increasing engine efficiency, and providing a versatile solution adaptable to various engine configurations.

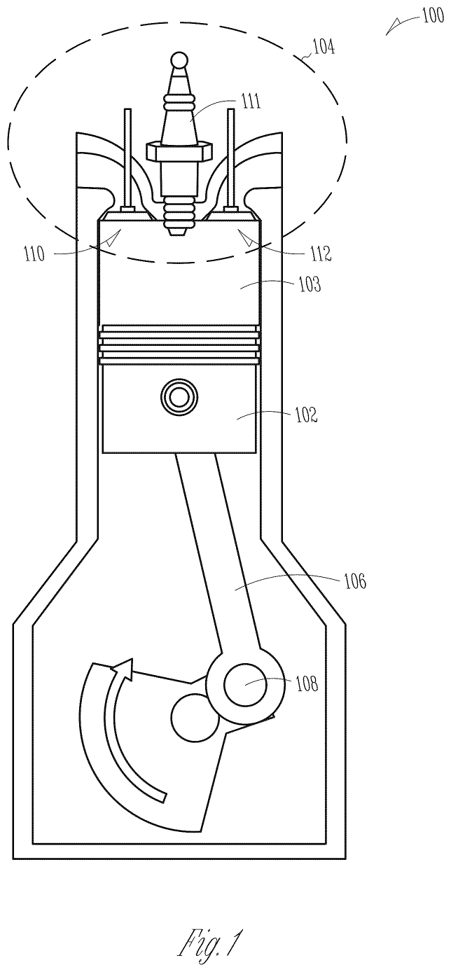

Referring now to FIG. 1, the engine cylinder 100 may include a cylinder wall that defines the combustion chamber 103, where fuel combustion occurs. Within the cylinder 100, the piston 102 may move up and down, driven by the combustion of fuel, which generates the mechanical energy to power the engine. The cylinder head 104 may be positioned at the top of the engine cylinder 100, sealing the chamber and housing components such as the inlet valve 110 and exhaust valve 112. In the context of a direct injection engine, the inlet valve 110 may provide for the flow of air into the combustion chamber 103, while the fuel is injected directly into the chamber. The exhaust valve 112 may facilitate the expulsion of combustion byproducts. The piston rod 106 may connect the piston 102 to the crankshaft 108, converting the reciprocating motion of the piston 102 into rotational motion, which drives the engine's output shaft and powers the vehicle's wheels or other machinery.

Turning now to FIG. 2, the cylinder head 104 is configured to seal the top of the engine cylinder 100, forming the upper boundary of the combustion chamber 103. It houses components for controlling the flow of combustion fluids into and out of the combustion chamber, as well as the components for controlling the ignition of the combustion process. In particular, the cylinder head facilitates the flow of air and fuel into the chamber and the expulsion of exhaust gases. Within the cylinder head 104, the inlet valve 110, exhaust valve 112, spark plug 111, and fuel injector 114 are housed, each serving respective functions in the combustion process.

The inlet valve 110 may be configured to allow air to enter the combustion chamber 103 during the intake stroke of the engine cycle. It generally includes a valve head and a stem, with the valve head featuring a conical upper surface configured to seat against a corresponding conical surface of the inlet. The exhaust valve 112 may be configured to expel combustion byproducts from the combustion chamber 103 during the exhaust stroke. Similar to the inlet valve, it includes a valve head and stem, with the valve head also having a conical upper surface that seats against a corresponding conical surface of the outlet. The spark plug 111 may be configured to ignite the air-fuel mixture within the combustion chamber 103. The spark plug may include an insulated electrode that generates a spark to initiate combustion. Alternatively, or additionally, the engine may be a compression-ignited engine and a spark plug may be omitted.

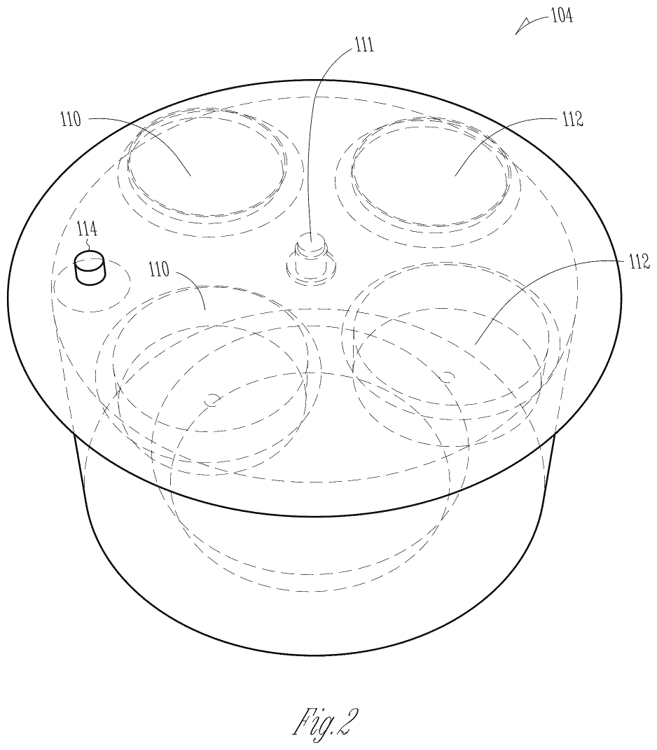

While not shown, a fuel delivery system may be provided that delivers pressurized fuel to a fuel rail and the fuel injector 114 may be in fluid communication with the fuel rail to receive the high-pressure fuel. The fuel injector 114 then, and as depicted in FIG. 3, may be configured to controllably deliver gaseous fuel directly into the combustion chamber 103, providing precise control over the fuel delivery rate and timing. The fuel injector 114 may be arranged in the cylinder head 104 such that a distal or bottom tip of the fuel injector 114 is exposed to the combustion chamber. In one or more examples, the fuel injector 114 may be located at the side of the cylinder, positioned between the valves, as shown in FIG. 2. However, the injector could be located elsewhere across the cylinder, depending on the specific engine design and requirements. The fuel injector 114 includes several components, such as the injector body 116, shoulder 118, extension portion 120, and injector cap 122.

With reference to FIG. 3, the injector body 116 may house internal components such as a solenoid or piezoelectric actuator to control opening and closing of an injector valve. The injector valve may be in the form of a needle valve that is actuated by the solenoid or piezoelectric actuator to reciprocate between a closed position where the needle is in seated engagement with a valve seat and an open position where the needle is lifted from seated engagement with the valve seat. In one or more examples, the solenoid or other actuation system may be arranged in the injector body and the needle valve and seat may be arranged in the extension portion 120 of the injector. In one or more examples, the injector may include a pressure regulator or control system to maintain the appropriate fuel pressure. Moreover, an electrical contact may be provided to place the injector in control communication with the engine's electronic control module unit (ECM) allowing for the injector to be controlled with suitable timing for proper engine operation.

With respect to the outer profile of the injector, the transition between the broader body 116 and the extension portion 120 may provide a shoulder 118, which may be used to seatingly engage the injector in a socket of the cylinder head 104. The extension portion 120 may extend distal or downward from the shoulder and may have a length selected to properly position the tip of the injector at or near the bottom surface of the cylinder head providing access to the combustion chamber. An injector cap 122, described in more detail below, may be arranged on a distal end of the extension portion 120.

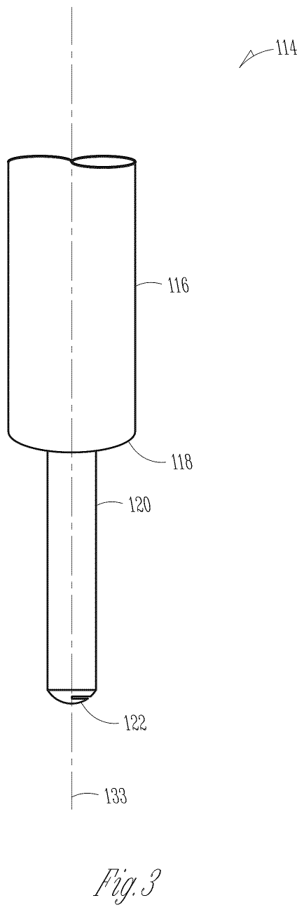

Turning now to FIGS. 4 and 5, the injector cap 122 is shown. The injector cap 122 may be configured for arrangement on the distal tip of the injector 114 and may be removably attached to the injector 114 or integrated into the distal tip. In still other examples, the injector cap may be attached to or otherwise integrated into the cylinder head. That is, for example, a sleeve may be provided in the cylinder head for receiving the injector and the cap may be attached to or integrated into the sleeve. Still other approaches may be provided for locating an injector cap or other fuel control device at or near the outlet of the injector to control the delivery of the fuel to the chamber.

The injector cap 122 may be configured to control the way the fuel enters the combustion chamber 103. In particular, it may control the direction the fuel flows as it enters the combustion chamber 103, but it may also control the shape of the gas formation as it enters the combustion chamber 103. For example, the injector cap 122 may redirect the fuel generally orthogonally across the combustion chamber 103 and relative to the axial axis 133 of the injector 114. Moreover, it may provide for a gaseous flow in the form of a radially propagating and simultaneously expanding flow forming a fan-shaped wave of fuel extending across a top portion of the combustion chamber 103. The injector cap 122 may include a cap body 124 and a cap head 131.

The cap body 124 may be configured for attaching the injector cap 122 to the distal end of the injector 114 and facilitating the flow of gaseous fuel from the injector valve to the cap head 131. The cap body 124 may have an outer cylindrical shape, although other outer cross-sectional shapes may be provided. The cap body may include a fastening portion designed for attachment to the distal tip of the injector. The fastening portion may include an internal threaded bore 134A allowing the cap body 124 to be threadably engaged with the distal tip of the injector 114. In other examples, the fastening portion may include a keyed bore or a smooth bore, and a circumferential or partially circumferential rib adapted for engaging a circumferential or partially circumferential groove in a detent relationship may be provided. In still other examples, a welded connection of the cap body to the distal tip of the injector may be provided. Still other types of fastening portions may be provided. Additionally, the cap body 124 may include an internal bore 134B that serves as a conduit for fuel, channeling the fuel from the injector valve to the cap head 131. In one or more examples, the internal bore 134B may be a continuation of the threaded bore 134A of the fastening portion. In some examples the internal bore 134B may be relatively short or may not exist at all. That is, in some cases, the tip of the injector 114 may pass generally fully through the cap body 124 and may approach a lower end of the cap body 124 such that a further bore 134B is not provided. In any case, fluid communication from the tip of the injector may be provided fully through the cap body 124 either by way of the injector tip extending fully through the cap body or, when stopping short, a further bore 134B

With particular reference to FIG. 5, the cap head 131 may be configured to redirect and control the shape of the flow of fuel exiting the injector, passing through the cap body 124, and exiting the cap 122. The cap head 131 may generally close off the internal bore 134B passing from the tip of the injector through the cap body 124 or, where not present, may generally close off flow emitted from the injector. That is, the cap head 131 may extend across a distal end of the cap body 124 substantially closing off the internal bore 134B at its distal end or closing off flow directly from the injector. In one or more examples, the cap head 131 may fully close off the internal bore 134B or the injector in an axial direction. As shown, the cap head 131 may include a spherical bottom-side 130 forming a domed cap head on the cap 122. In one or more examples, the spherical profile may be defined by a radius 136. In one or more examples, the cap head 131 may be a generally solid cap head with a recess 138 in a topside thereof where the internal bore 134B extends slightly into the top side of the cap head 131 or the recess provides a cavity adjacent to the tip of the injector. The recess 138 may have a depth 140 measured from a top of the cap head 131 to a bottom 139 of the recess 138.

For purposes of releasing and controlling the fuel flow, the cap head 131 may define a radially facing slot 128 extending into the cap head 131 along a plane generally orthogonal to the axial axis 133 of the injector 114 and the cap 122. The bottom side of the slot may be arranged to align with the bottom 139 of the recess to provide the fluid communication. In one or more examples, the slot 128 may extend from a surface of the spherical bottom 130 of the cap head 131 radially inward to the axial axis 133 of the injector 114 and the cap 122. As show in FIG. 6, which is a top-down view of the cap head 131, as a result of the spherically-shaped bottom 130 and the slot 128 extending from the surface to the axial axis 133, the slot 128 may define an opening at the surface that encompass an included angle 142 of approximately 180 degrees about the spherical cap head. While an included angle of 180 degrees has been described, still other included angles may be provided ranging from approximately 30 degrees to approximately 270 degrees, or from approximately 45 degrees to approximately 235 degrees, or from approximately 60 degrees to approximately 150 degrees, or from approximately 90 degrees to approximately 135 degrees, or having other ranges. Still further, while a continuous uninterrupted slot is shown, slot segments may be provided that create several openings that encompass the included angle and define the overall slot opening. That is, two, three, four, or more slot segments may be used that are separated by portions of the cap head where the several slot segments define openings at the surface that extend in line with one another to cover the included angle and form the full slot opening.

The slot 128 may be a generally rectangular slot when viewed in cross-section as shown in FIG. 5 and, as such, may define a deflector in the form of a generally flat dispersing surface 144 on a bottom side of the slot 128 and a generally flat reflection surface 145 on a top side of the slot. The dispersing surface 144, when viewed from above as in FIG. 6, may be defined by the included angle 142 and a radius 146 and forming a sector of a circle. The radius 146 may be defined by the axial position of the slot 128 relative to the spherical surface 130 as understood from a review of FIG. 5. The reflection surface 145 may include an inner radiused edge defined by a wall of the recess 138 and an outer radiused edge defined by the spherical surface 130.

It is to be appreciated that while a domed cap head 131 has been shown, alternatively, a generally cylindrical cap head with a flat circular bottom surface may be provided. The slot may extend into the side of the cylindrical cap head and a variety of included angles may be provided. Still other cap head designs may also be provided.

### Industrial Applicability

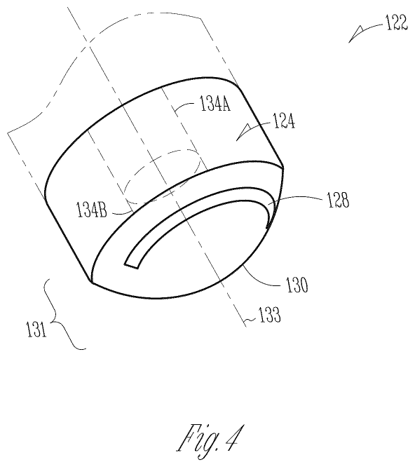

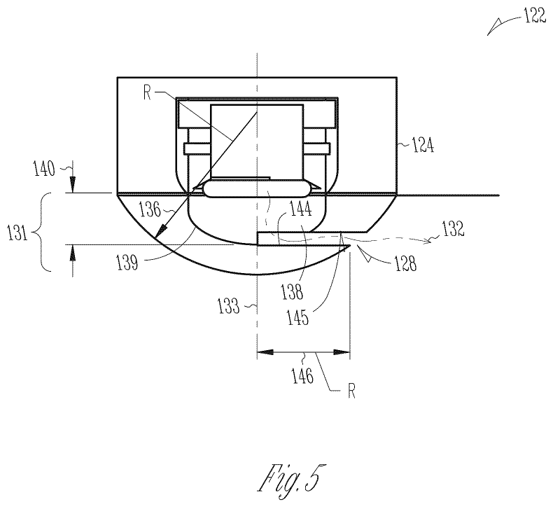

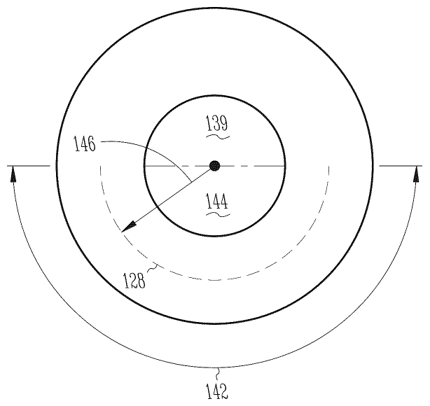

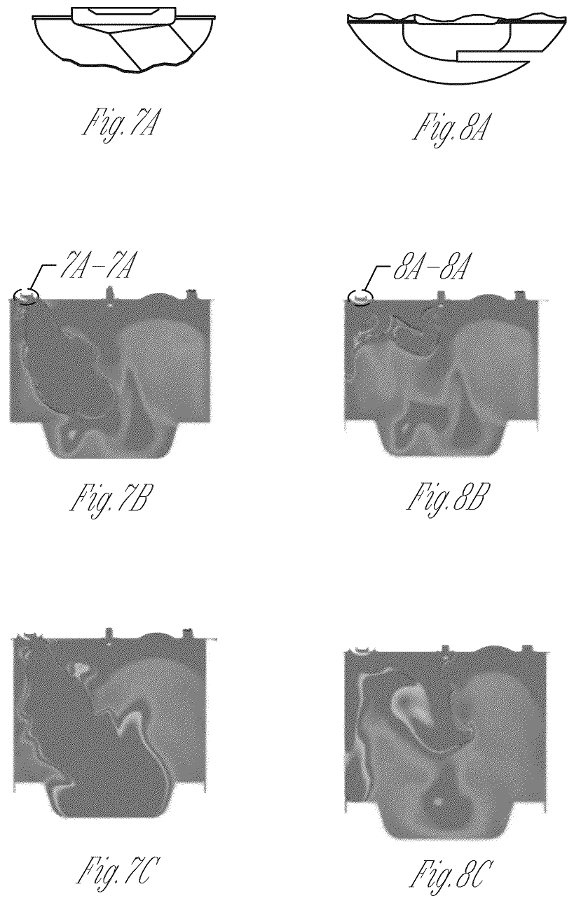

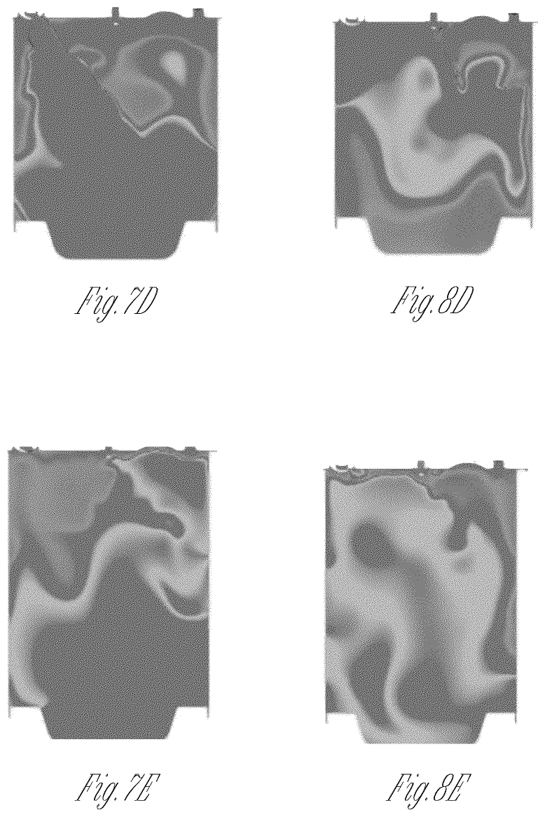

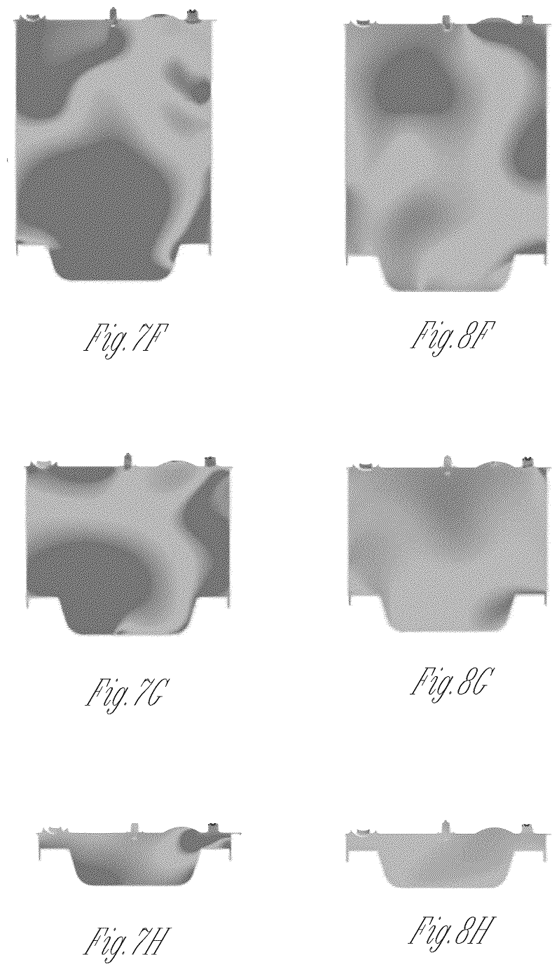

In operation and use, the injector cap 122 may be arranged on a direct injection fuel injector. The cap may facilitate enhanced fuel-air mixing efficiency by redirecting the gaseous fuel orthogonally using the dispersing surface and allowing it to exit through a slot as a radially travelling and expanding fanned out wave. As shown by a comparison of FIGS. 7A-7H with FIGS. 8A-8H, this may improve the mixing of the fuel with the other combustion components in the combustion chamber. This may provide for increased engine efficiency and reduced emissions.

FIGS. 7B-7H show a progression of fuel mixing using a conventional jet-based injector cap. That is, as shown in the schematic of FIG. 7A, the progression of mixing of FIGS. 7B-7H may be based on a jet-based injector cap having a downward and slightly angled jet channel. In contrast, the progression of mixing of FIGS. 8B-8H may be based on the cap design described herein and reproduced as FIG. 8A.

As shown in FIG. 7B, when the fuel is injected into the combustion chamber during the intake stroke, the fuel may penetrate the volume of the combustion chamber in the form of an elongate and downward extending plume. As the intake stroke continues, FIG. 7C shows that the plume may reach the bottom of the combustion chamber (e.g., top of piston) and begin to pool across the top of the piston. FIG. 7D shows further pooling at the bottom of the chamber and as the intake stroke is completed (e.g., piston is at bottom dead center) at FIG. 7E, most of the injected fuel is pooled down on top of the piston and very little is mixed with the other combustion components in the chamber. As can be seen from a review of FIGS. 7F through 7H, as the piston returns upward to compress the gases, the fuel mixing does not fully recover from the pooling near the top of the piston and at FIG. 7H, unmixed fuel still remains in the bottom corners of the combustion chamber at the top of the piston.

In contrast, as shown in FIG. 8B, fuel injected using the present injector cap begins dispersing across the combustion chamber in the form of radially directed and expanding wave where much of the fuel remains near the top of the combustion chamber. In FIG. 8C, while the fuel is being drawn downward slightly, very little if any fuel is pooling at the top of the piston. At 8D, a relatively large amount of mixing has already occurred and by the time the piston reaches bottom dead center at FIG. 8E, most of the fuel has mixed with the other combustion components. Moreover, to the extent that fuel remains unmixed, portions of the unmixed fuel are located throughout the chamber and not pooled on top of the piston or in one location, for that matter. A review of FIGS. 8F-8H shows that as the piston returns upward further mixing occurs until a generally uniform distribution of fuel is present in a generally homogenous combustion gas.

The above detailed description is intended to be illustrative, and not restrictive. The scope of the disclosure should, therefore, be determined with references to the appended claims, along with the full scope of equivalents to which such claims are entitled.

1. An injector cap for controlling introduction of gaseous fuel into a combustion chamber of an engine cylinder, the injector cap comprising:
a cap head having a top configured for facing a fuel ejecting tip of a fuel injector with an axial axis along which the fuel injector ejects the gaseous fuel, the cap head having a recess in the top with a radiused wall and a curvilinear bottom and the cap head having a slot extending radially into the cap head and defining a fuel dispersion surface arranged generally orthogonal to the axial axis and configured to disperse the gaseous fuel ejected from the fuel injector through the slot, the slot having a generally rectangular cross-section with the fuel dispersion surface on a bottom side of the slot that is aligned with the curvilinear bottom of the recess.

2. The injector cap of claim 1, further comprising a cap body configured for arrangement on or integration with the fuel ejecting tip of the fuel injector to support the cap head relative to the fuel injector.

3. (canceled)

4. The injector of claim 1, wherein the slot is in fluid communication with the recess.

5. The injector of claim 1, wherein the slot comprises a reflection surface on a top side thereof.

6. (canceled)

7. The injector of claim 5, wherein the cap head is a domed cap head.

8. The injector of claim 5, wherein the cap head is a cylindrical cap head.

9. The injector of claim 1, wherein the slot defines an opening on an outer surface of the cap head.

10. The injector of claim 9, wherein the slot comprises a plurality of slot segments and the opening comprises a plurality of openings.

11. The injector of claim 9, wherein the opening encompasses an included angle of approximately 180 degrees.

12. The injector of claim 9, wherein the cap head is a domed cap head and the dispersion surface has the shape of a sector of a circle defined by the opening on an outer edge thereof and an included angle of the opening.

13. An injector cap for controlling introduction of gaseous fuel into a combustion chamber of an engine cylinder, the injector cap comprising:
a cap body for arrangement on the fuel ejecting tip of a fuel injector, and
a cap head coupled to the cap body and comprising a recess in a top side thereof with a radiused wall and a curvilinear bottom and comprising a deflector aligned with the curvilinear bottom of the recess, the cap head configured to receive a flow of gaseous fuel from the fuel injector in an axial direction and, using the curvilinear bottom aligned with the deflector, generate a radially propagating and simultaneously expanding flow forming a fan-shaped wave of fuel extending across a top portion of the combustion chamber and generally orthogonal to the axial direction.

14. The injector cap of claim 13, wherein the cap head comprises a slot extending radially into the cap head and defining a fuel dispersion surface forming the deflector.

15. The injector cap of claim 14, wherein the cap head is a domed cap head.

16. The injector cap of claim 14, wherein the cap head is a cylindrical cap head.

17. The injector cap of claim 15, wherein the fuel dispersion surface has the shape of a sector of a circle.

18. A fuel injector, comprising:
a body portion comprising an actuator;
a needle valve operable by the actuator; and
an injector cap according to claim 1.

19. A combustion engine, comprising:
a cylinder;
a piston arranged to reciprocate in the cylinder;
a rod pivotally coupled to the piston to reciprocate with the piston;
a crank shaft pivotally coupled to the rod to be driven by the rod due to the reciprocating motion of the piston; and
a fuel injector according to claim 18.
